(19) United States
(12) Patent Application Publication
(10) Pub. No.: US 2003/0218340 A1
(43) Pub. Date: Nov. 27, 2003

(54) Latch arrangement

(76) Inventors: Peter Coleman, Birmingham (GB); Gurbinder Kalsi, Oldbury (GB)

Correspondence Address: CARLSON, GASKEY & OLDS, P.C., 400 WEST MAPLE ROAD, SUITE 350, BIRMINGHAM, MI, 48009, US

(21) Appl. No.: 10/412,609

(22) Filed: Apr. 11, 2003

(30) Foreign Application Priority Data
Apr. 12, 2002 (GB) GB 0208434.1

(51) Int. Cl. E05C 1/12

(52) U.S. Cl. 292/169.11

(57) ABSTRACT

A latch arrangement includes a latch and a release mechanism. The arrangement is operable such that with the latch in an unlocked latched first condition, an initial actuation of the release mechanism changes the state of the latch to a latched second condition, which is different from the first condition. A subsequent actuation of the release mechanism unlatches the latch.

### CROSS REFERENCE TO RELATED APPLICATIONS

This application claims priority to United Kingdom (GB) patent application number 0208434.1 filed on Apr. 12, 2002.

### BACKGROUND OF THE INVENTION

The present invention relates to a latch arrangement, particularly for use on land vehicles such as automobiles.

Known vehicle door latches are required to keep an associated vehicle door in a closed position in the event of a road accident. Under such circumstances, a closed vehicle door contributes significantly to the strength of the passenger safety cell. In the event that the door is forced open during a road accident, the passenger safety cell strength is compromised, potentially endangering the passengers and driver of the vehicle.

Occasionally, an impact occurring during a crash may deform the vehicle door such that the normal release mechanism of the latch is inadvertently operated, releasing the door. As mentioned, this would be undesirable.

There are also known latches which are power openable, wherein the latch is driven by a power actuator such as an electric motor to open the signal to operate the power actuator which is generated by an initial movement of an outside door handle associated with the latch/power actuator. The initial movement of the outside door handle simply operates a signaling switch, and the force required to lift the outside door handle during this initial movement is very low.

However, in the event of malfunction of the power actuator, further movement of the outside door handle causes mechanical components of the door latch to be moved to release the latch. The force required to lift the door handle during this subsequent movement is considerably more than that force required to lift the handle during the initial movement.

Also, there is an ongoing requirement for vehicles to have reduced noise levels, and in particular reduce wind noise levels. Reduced wind noise levels can be achieved by increasing the seal load between the door and the adjacent door aperture of the vehicle. However, an increase in seal load also increases the force required to unlatch the latch.

It is difficult to control the tolerances on seal loads between various doors of a vehicle, and as such, the force required to unlatch the latch on different doors of the same vehicle varies significantly. During power opening of a door latch, different doors of the same vehicle may take different times to open. As an example, where a power actuator takes a significantly longer time than usual to open its associated door, the person lifting the door handle may well have moved the door handle from the initial position into the manually opening phase of the door handle. As such, a person opening different doors of the same vehicle can be required to input significantly different forces into each door handle.

### SUMMARY OF THE INVENTION

The present invention provides a door latch that is less likely to unlatch during an accident.

A latch arrangement according to the present invention includes a latch and a release mechanism operable such that the release mechanism has an openable first condition. In the first condition, and with the latch fully latched, an initial operation of the release mechanism changes the state of the release mechanism to an openable second condition, while maintaining the latch fully latched. A subsequent operation of the release mechanism then unlatches the latch.

Another object of a preferred embodiment of the present invention is to alleviate the problem of different opening times. According to this aspect of the present invention, the latch arrangement is preferably further operable by a power actuator.

In a disclosed power openable door latch, which includes the above-described initial and subsequent operation of a release mechanism, the initial operation moves only a certain number of components of the latch. The tolerances on these particular components can be tightly controlled, since the components are chosen to be part of a latch assembly. Thus, the force required to move these components is relatively low, and the force required to fully actuate an outside or inside door handle on the initial operation can remain low. The force is consistent across the several door handles of the same vehicle.

The time taken to manually fully lift an outside or inside door handle is considerably longer than the time required for the power actuator to unlatch the latch. Thus under normal circumstances, when the latch is being power unlatched, the door will open while the outside door handle is being lifted (i.e. between initial movement and the fully actuated position). This is true even though the action of lifting the outside or inside door handle has not yet begun to mechanically unlatch the latch. It is therefore easier to achieve a consistent “feel” to all latches on a particular vehicle.

### BRIEF DESCRIPTION OF THE DRAWINGS

FIG. 1 is a view of a latch arrangement according to the present invention in an unlocked fully latched first condition.

FIG. 2 is a view of FIG. 1 part way through a first actuation of the release mechanism.

FIG. 3 is a view of FIG. 1 having completed the first actuation.

FIG. 4 is a view of the latch of FIG. 1 with the release mechanism having been released and with the latch in a latched second condition.

FIG. 5 is a view of the latch of FIG. 1 shown in a released position, having been mechanically released.

FIG. 6 is a view of FIG. 1 shown in a released position having been released by a power actuator.

FIG. 7 is a view of FIG. 1 shown in a locked condition.

FIG. 8 is a view of FIG. 1 shown in an unlatched condition with the release handle in a rest position.

FIG. 9 is a view of various components of FIG. 1 shown in isolation for clarity.

FIG. 10 is a view of the claw of FIG. 1 shown in isolation.

FIG. 11 is a view of a further embodiment of the present invention.

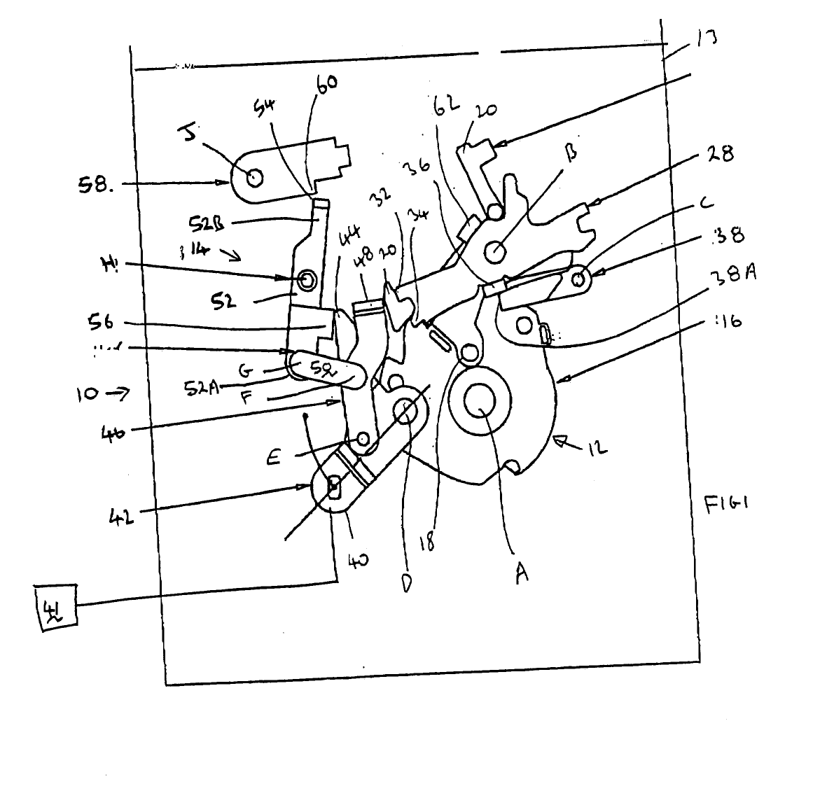

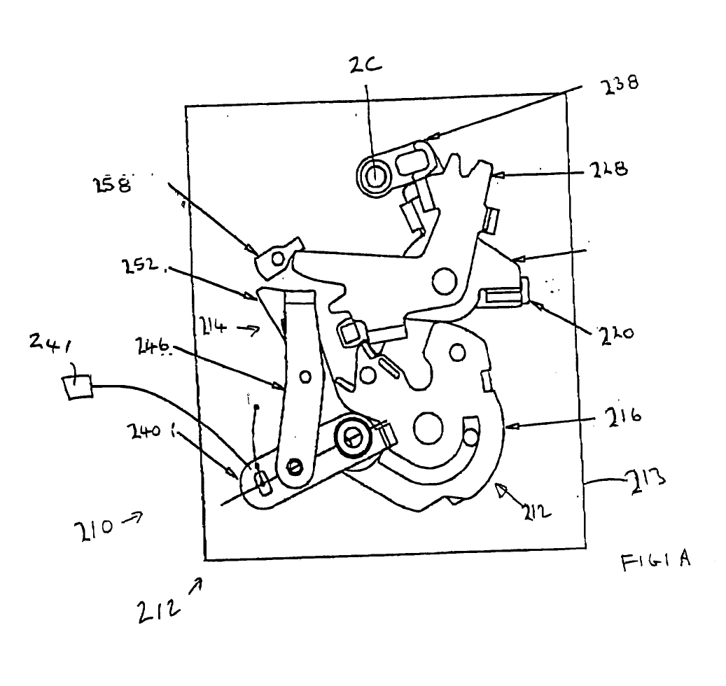

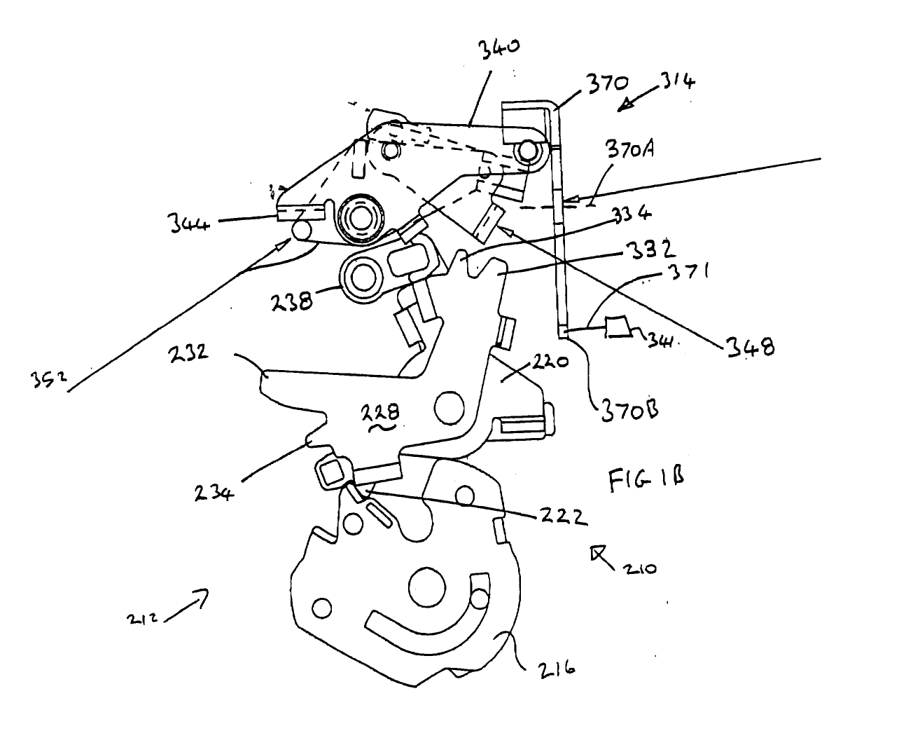

FIGS. 1A to 7A are views corresponding to FIGS. 1 to 7 respectively, of a yet further embodiment of a latch (210) arrangement according to the present invention, showing just components associated with the outside handle 241 for clarity.

FIG. 12 is a view of the embodiment of FIG. 1A shown in a locked condition with the outside handle pulled.

FIG. 13 is a close up view of part of FIG. 1A.

FIGS. 1B to 7B are views corresponding to FIGS. 1A to 7A showing the embodiment of FIG. 1A (latch 210) but showing just components associated with the inside handle 341 for clarity.

FIG. 14 shows the latch of FIGS. 1A in a child safety on condition with the inside handle pulled.

FIG. 15 is an enlarged view of FIG. 1.

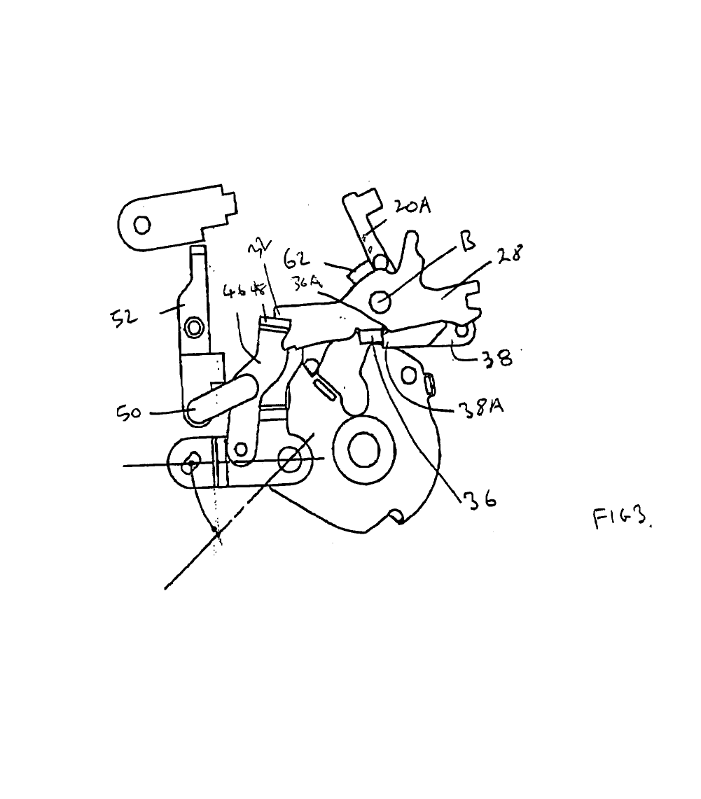

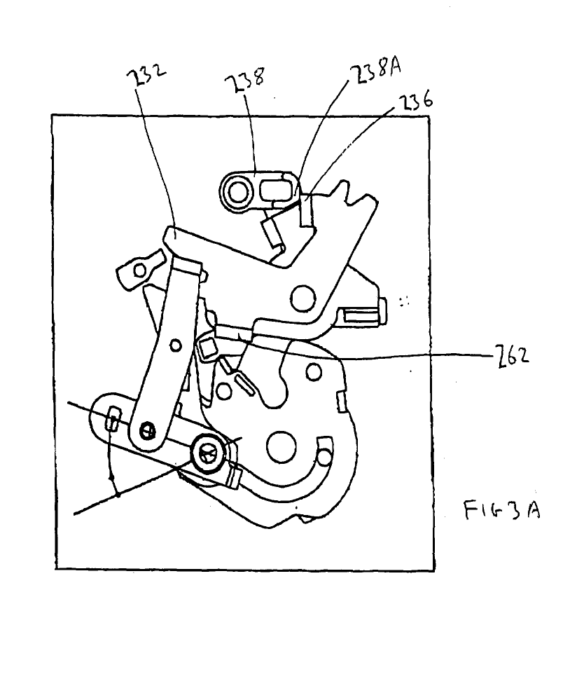

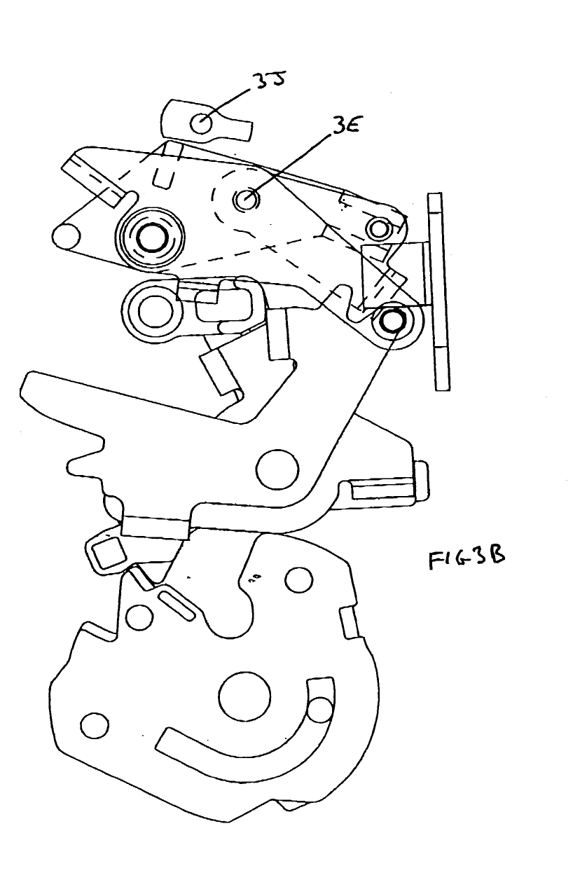

FIG. 16 is an enlarged view of FIG. 3.

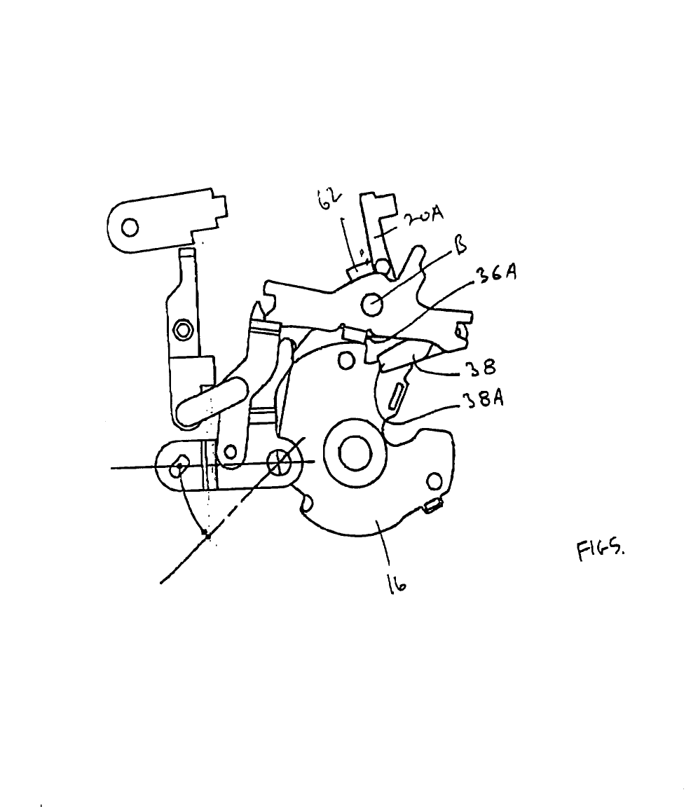

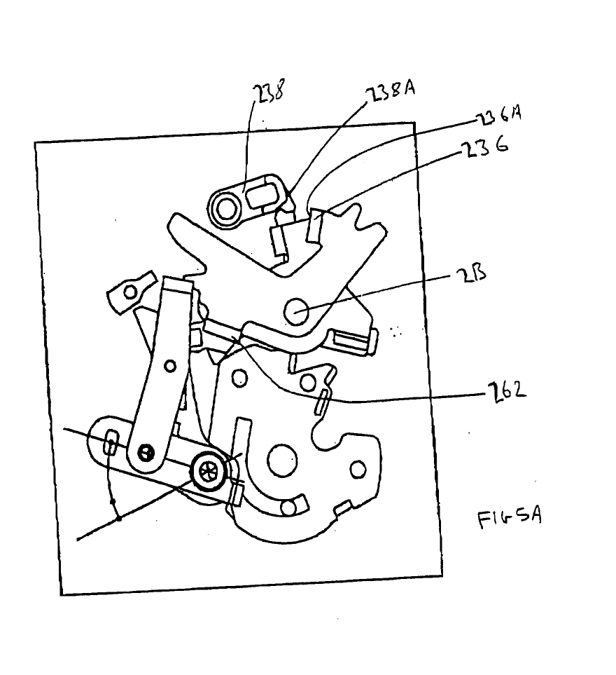

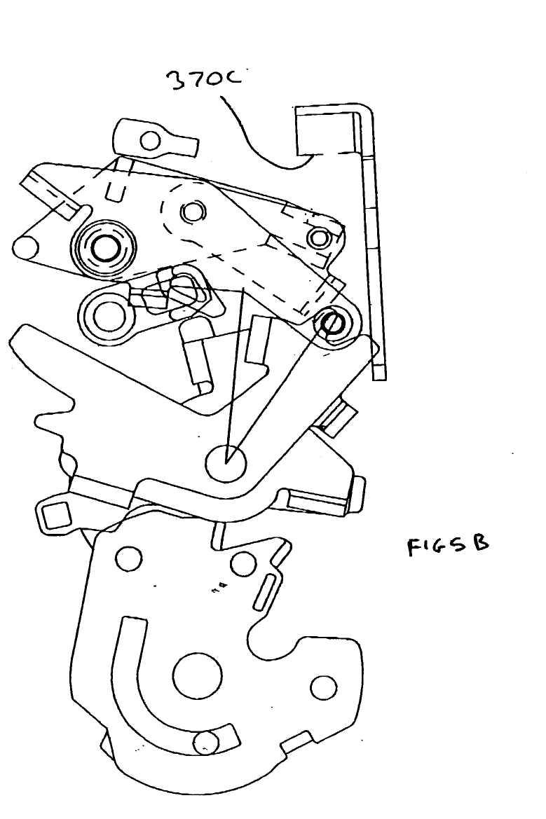

FIG. 17 is an enlarged view of FIG. 5.

### DETAILED DESCRIPTION OF THE PREFERRED EMBODIMENT

FIGS. 1 through 5 show a latch arrangement 10 including a latch 12 and a release mechanism 14. The latch 12 includes a pivotally mounted latch bolt in the form of claw 16 that pivots about axis A. Claw 16 can move between a fully closed position as shown in FIG. 1, whereupon it retains a striker 18, and an open position as shown in FIGS. 5, 6 and 8, wherein the striker 18 is released, thus allowing opening of the door.

The claw can also be retained in a “first safety” position (not shown) whereupon the associated door cannot be opened, but nevertheless is not fully shut.

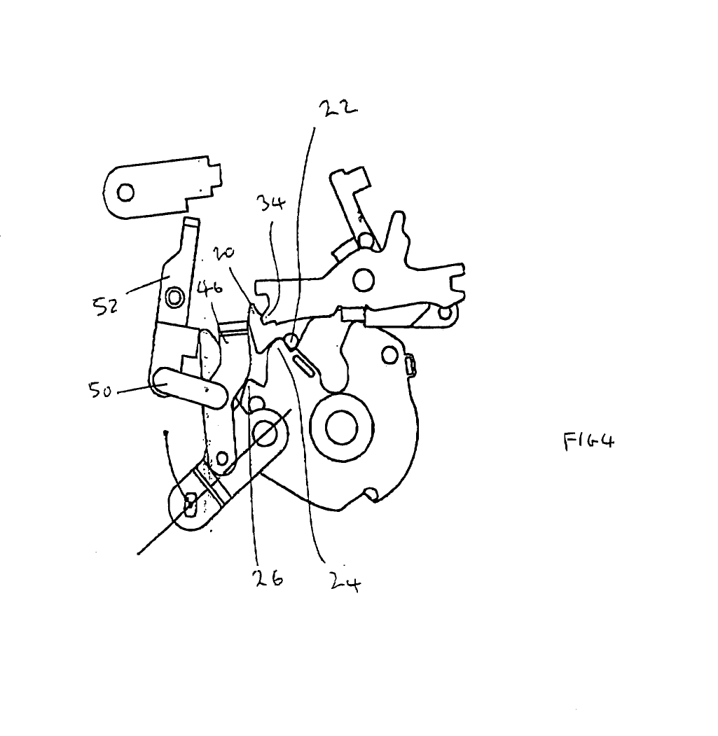

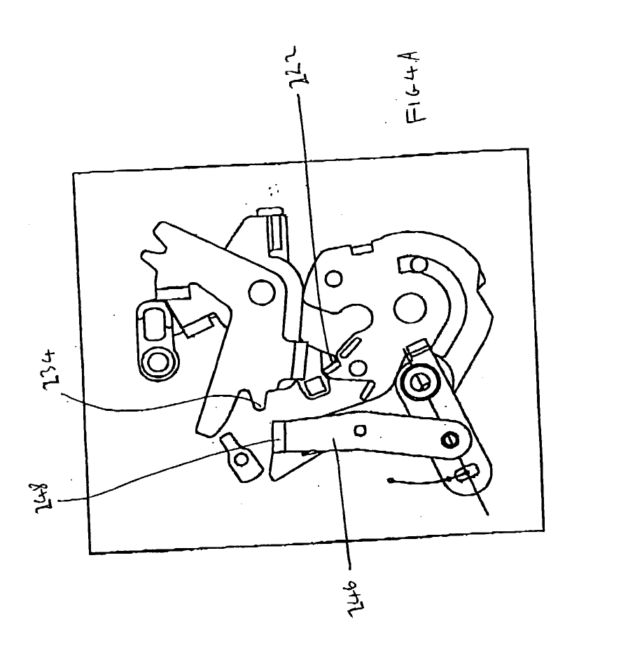

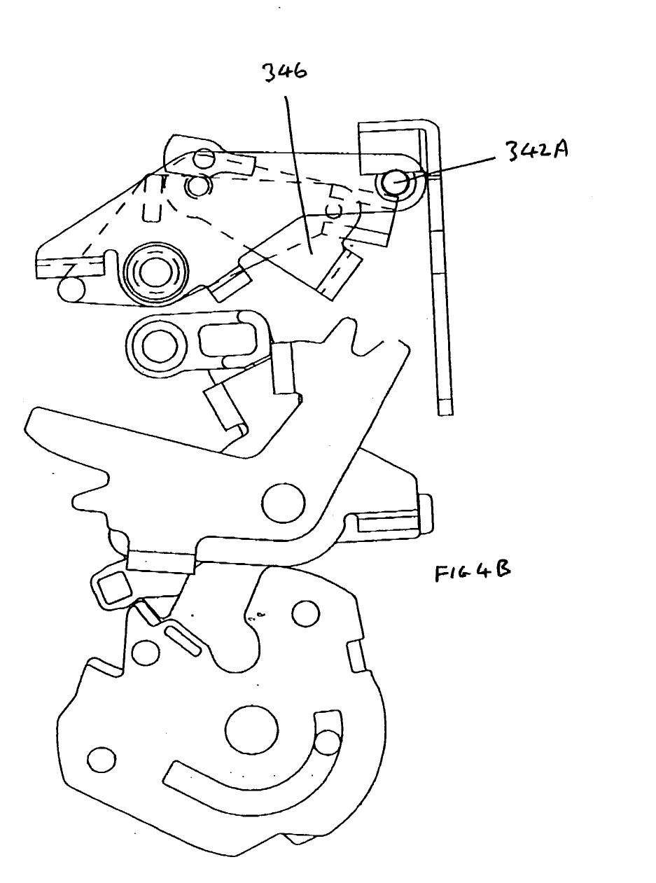

The latch 12 further includes a first pawl 20 pivotally mounted to a chassis 13 (shown schematically) of the latch at pivot B. Pawl 20 includes a pawl abutment 22 for engagement with claw abutment 24, when the claw is in its fully closed position (FIG. 4) or claw first safety abutment 26, when the claw is in its first safety position.

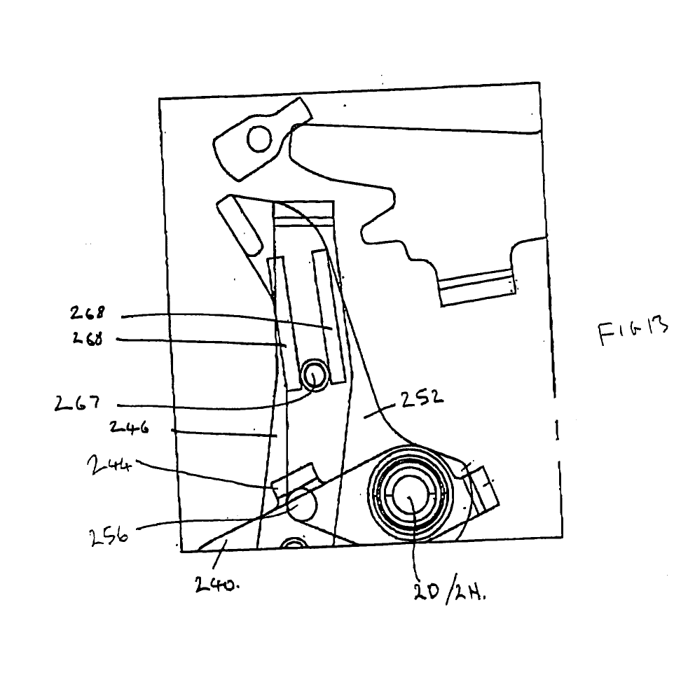

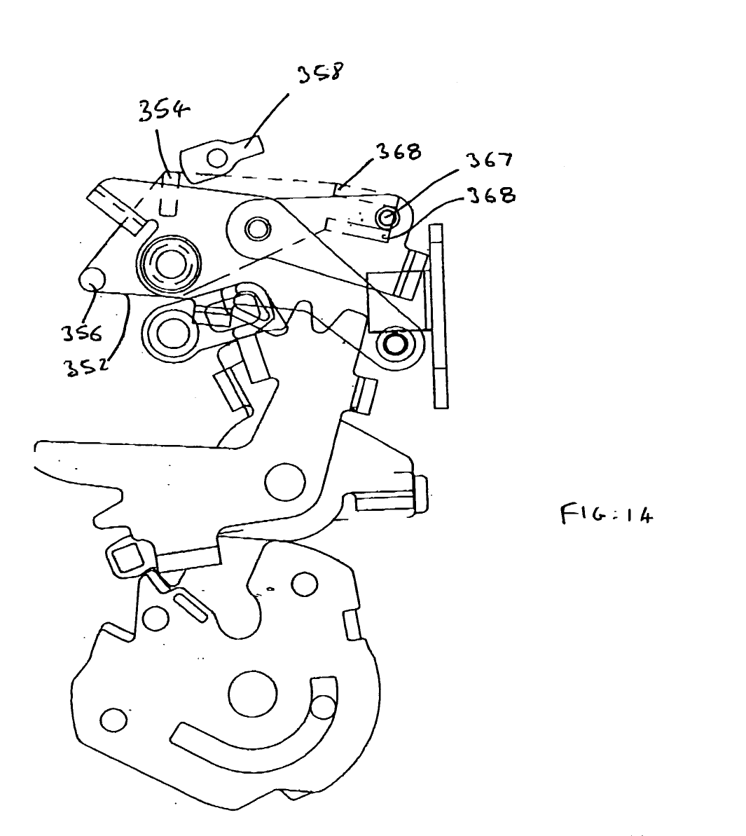

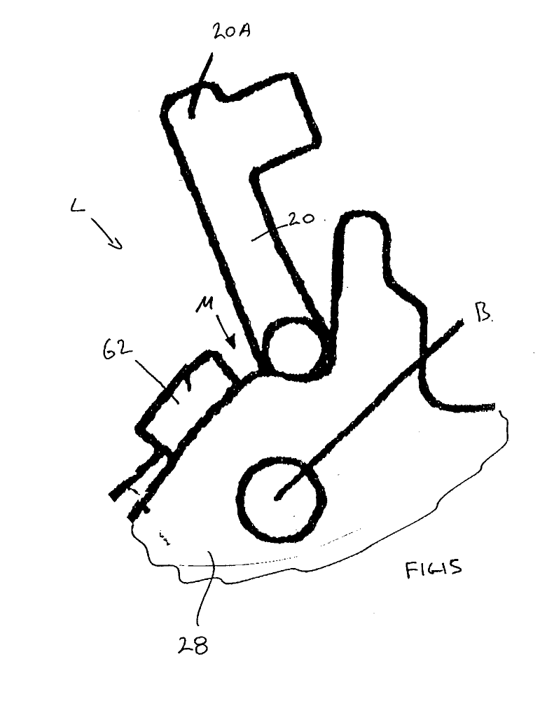

As best shown in FIG. 10, claw 16 includes a claw release abutment 27 having end 27A. The pawl abutment 22 rests against end 27A when the claw is in the open position (FIGS. 5, 6 and 8). It should be noted that claw release abutment 27 is positioned at a radius RI that is greater than radius R2 of the claw abutment 24 and first safety abutment 26. Thus, with the latch in a closed or first safety position, claw abutment 22 sits at radius R2, closer to axis A than when the pawl abutment 22 is resting on claw release abutment 27, with the latch in the open position. Pawl 20 is generally planar and sits below pawl lifter 28 in the position shown in FIG. 1. Pawl lifter 28 is also generally planar, and pivotally mounted at pivot B.

In FIG. 1, it can be seen that pawl lifter 28 includes first ratchet tooth 32, second ratchet tooth 34, and abutment 36. A second pawl 38 is pivotally mounted at pivot C to the chassis of the latch. Second pawl 38 can be engaged-with end 36A of abutment 36 as shown in FIGS. 3 and 4 and can be disengaged from end 36A as shown in FIGS. 1, 2 and 5, as will be further described below.

Outside release lever 40 is connected to an end 42 of outside lease handle 41 (shown schematically in FIG. 1). Outside release lever 40 is pivotally attached to the chassis 13 of the latch at pivot D, and includes a projection 44.

A ratchet lever 46 is pivotally mounted at pivot E, between pivot D and end 42. Ratchet lever 46 includes ratchet abutment 48, at an end remote from pivot E.

A first link pivot F is situated between ratchet abutment 48 and pivot E. First link pivot F pivotally connects link 50 with ratchet lever 46. The end of link 50 remote from first link pivot F is pivotally mounted, at second link pivot G, to end 52A of lock link 52.

Lock link 52 is pivotally mounted at pivot H to the chassis 13 of the latch. An end 52B of lock link 52 includes a lock abutment 54. Between pivot H and end 52A, lock link 52 further includes a return abutment 56. Lock toggle 58 is pivotally mounted at pivot J to the chassis of the latch and includes toggle abutment 60.

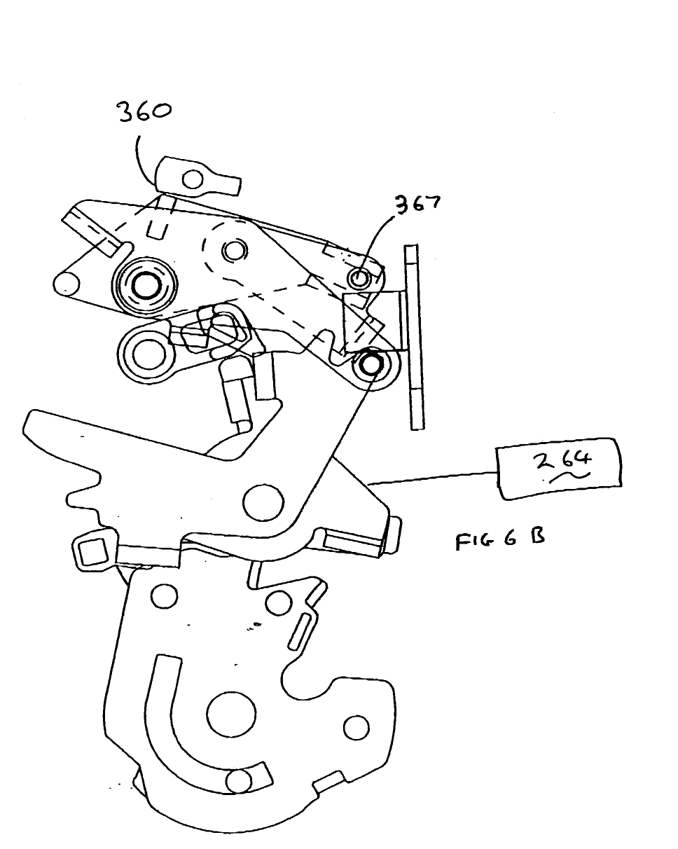

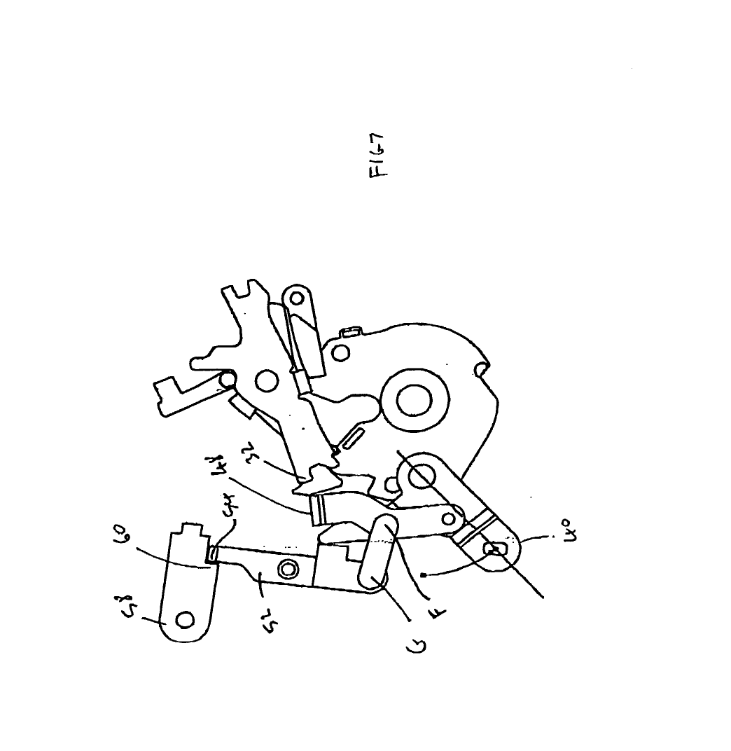

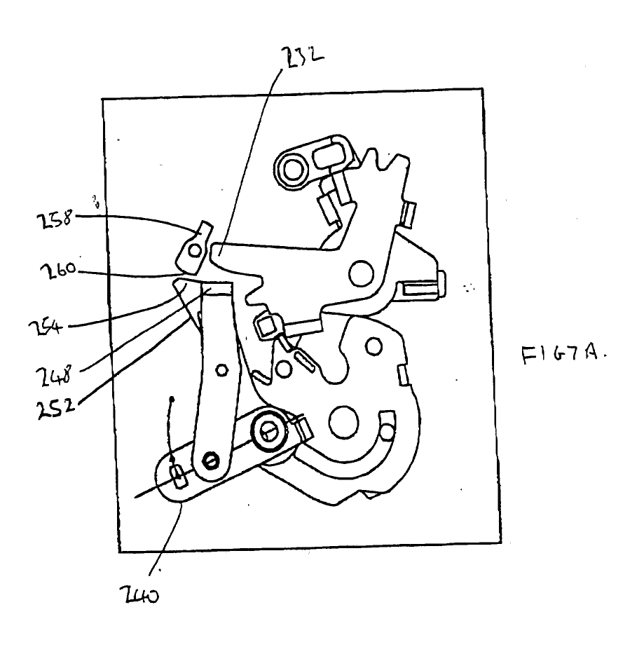

Lock link 52, outside release lever 40, pawl lifter 28 and first pawl 20 are all biased in a counter-clockwise direction (relative to the FIG. 1 illustration) by appropriate bias means, such as springs (not shown). Claw 16 and second pawl 38 are both biased in a clockwise direction by appropriate bias means, such as springs (not shown). The movement of link 50 and ratchet lever 46 is controlled by the combination of the lock link 52, outside release lever 40 and pawl lifter 28. Thus, link 50 and ratchet lever 46 are not required to be biased either clockwise or counter-clockwise. Lock toggle 58 can be moved between positions shown in FIGS. 1 and 7 by an actuator (not shown).

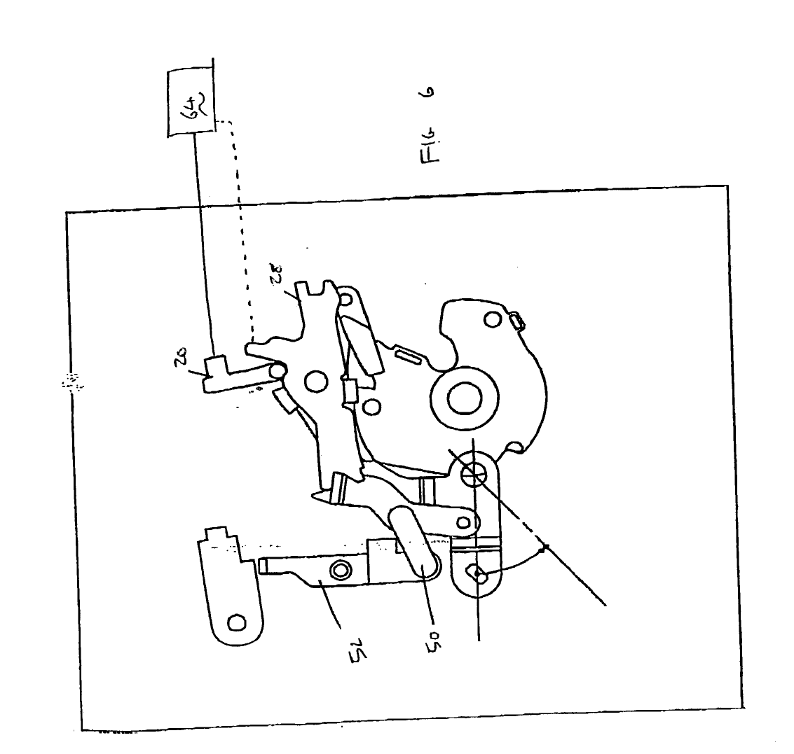

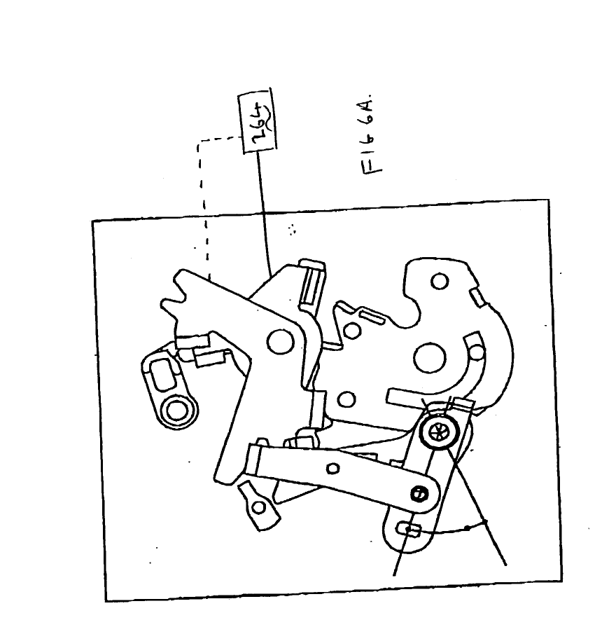

An actuator 64 (shown schematically in FIG. 6) is connected to the first pawl 20 and can be actuated to rotate the first pawl in a clockwise direction so as to release the latch. Note that in alternate embodiments, the actuator 64 could be connected to the pawl lifter 28 (as shown in dashed line in FIG. 6) in order to rotate the pawl lifter, and hence the pawl in a clockwise direction to release the latch.

FIGS. 1 through 5 show the sequence of events required to manually release the latch, in the event of failure of the power unlatching actuator 64.

FIG. 1 shows the latch in a fully latched condition. Pawl abutment 22 of first pawl 20 engages claw abutment 24 retaining the claw in its closed position.

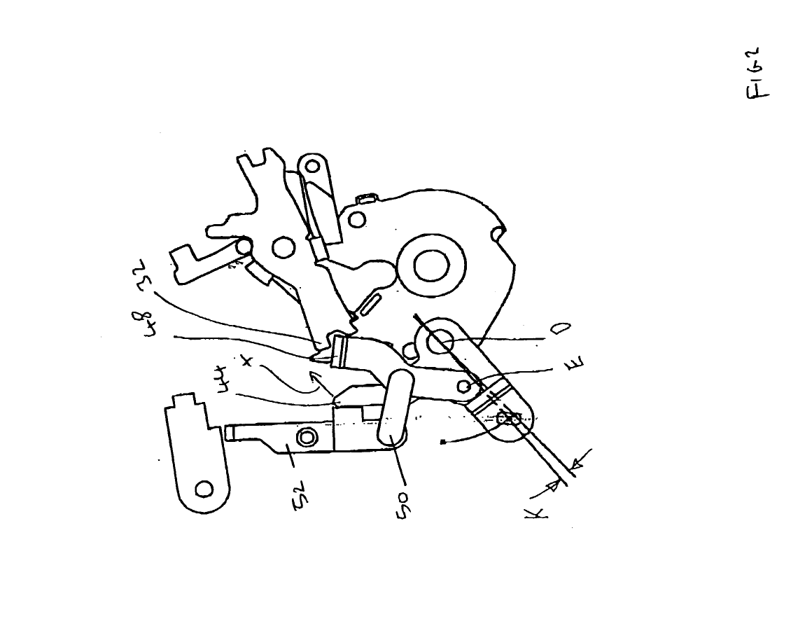

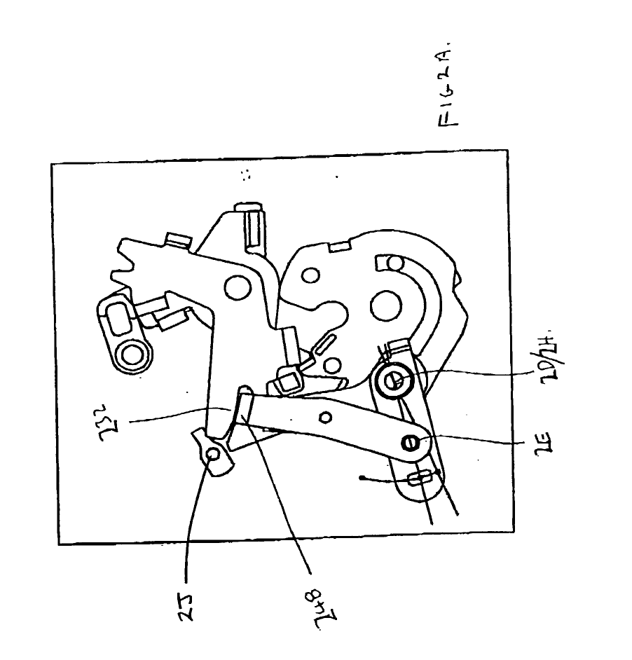

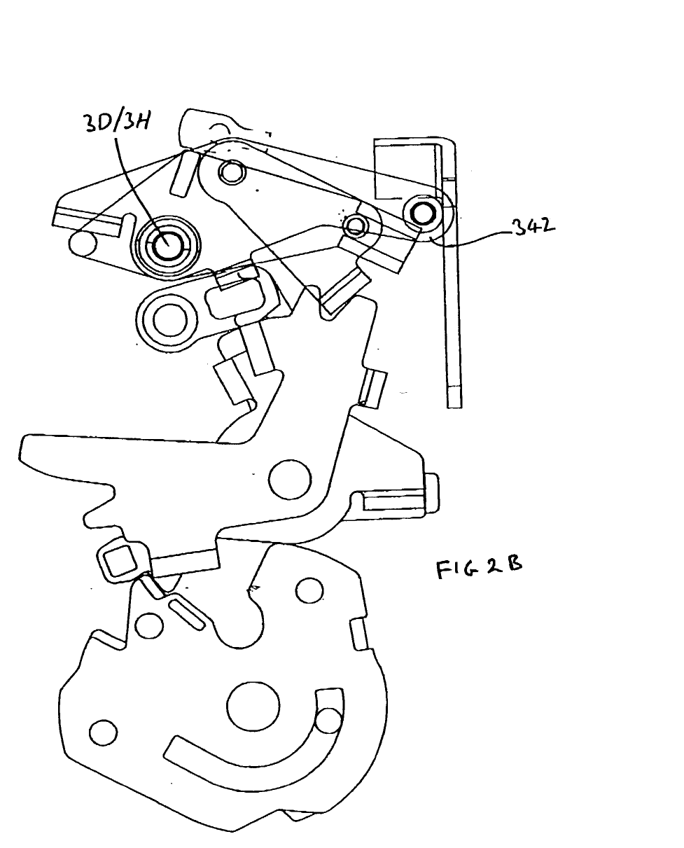

FIGS. 1 and 7 shows all components in an identical position other than toggle lock 58. As shown in FIG. 1, toggle lock 58 has been pivoted counter-clockwise such that lock abutment 54 does not align with toggle abutment 60. As shown in FIG. 7, lock toggle 58 has been pivoted clockwise such that lock abutment 54 is aligned with toggle abutment 60. FIG. 7 shows the latch arrangement in a locked condition and FIG. 1 shows the latch arrangement in an unlocked condition. However, it should be noted that, as shown in FIG. 1, the lock link 52 is nevertheless in a lockable position, since toggle lock 58 can be pivoted clockwise. In contrast, the lock link 52, as shown in FIGS. 2 and 3, is not in a lockable position, since lock toggle 58 cannot be pivoted clockwise.

It should also be noted from FIG. 1 that projection 44 of outside release lever 40 is in engagement with return abutment 56 of lock link 52. This engagement causes lock link 52 to be positioned as shown in FIG. 1, i.e., clockwise when compared with the position of lock link 52 as shown in FIG. 2.

In FIG. 2, the outside release lever 40 has been pivoted clockwise about pivot D through a relatively small angle K. This pivoting moves projection 44 clockwise about pivot D in the general direction of arrow X. This in turn has allowed lock link 52 to pivot counter-clockwise, moving link 50 generally to the right when viewing FIG. 2. This movement causes ratchet lever 46 to pivot clockwise about pivot E such that ratchet abutment 48 is substantially engaged behind first ratchet tooth 32. At this stage in the movement illustrated in FIG. 2, pawl lifter 28 and first pawl 20 remain in the same position as shown in FIG. 1.

FIG. 3 shows the outside release lever 40 having been moved to its fully actuated position (through a total of 45°). Lock link 52 remains in the same position as shown in FIGS. 2 and 3. However, ratchet lever 46 has been moved generally upwards.

The engagement between ratchet abutment 48 and first ratchet tooth 32 has caused the pawl lifter 28 to pivot clockwise from its position in FIG. 2. This clockwise rotation of pawl lifter 28 has allowed abutment 38A of second pawl 38 to slide past edge 36B of abutment 36 and engage end 36A of abutment 36, thus preventing pawl lifter 28 from subsequently rotating counter-clockwise about pivot B.

Pawl lifter abutment 62 has approached but not yet moved arm 20A of pawl 20. The pawl lifter 28 is moveable relative to the first pawl 20 by virtue of a lost motion connection between pawl lifter and the first pawl. This lost motion connection is best seen with reference to FIGS. 15, 16 and 17. The lost motion connection is generally indicated at L, and is in the form of a gap M between pawl lifter abutment 62 and a lower portion of arm 20A. As pawl lifter 28 is rotated from the position shown in FIG. 15 to the position shown in FIG. 16, gap M is closed. However, the arm 20 is shown in the same position in FIGS. 15 and 16. Thus the motion of pawl lifter 28 when moving from the position shown in FIG. 15 to the position shown in FIG. 16, is not reflected in motion of pawl 20. However, continued rotation of pawl lifter 28 from the position shown in FIG. 16 to the position shown in FIG. 17 directly rotates arm 20A, and hence pawl 20. Thus when moving from the position shown in FIG. 16 to the position shown in FIG. 17, there is no lost motion, since gap M has been closed.

For ease of comparison, FIG. 17 shows, in dotted outline, the superimposed position of arm 20A of FIG. 16. It is therefore apparent that the rotational movement of pawl lifter 28 from the position shown in FIG. 15 to the position shown in FIG. 16 is “lost” in respect of rotational movement of arm 20A. However, the rotational movement of pawl lifter 28 from the position shown in FIG. 16 to the position shown in FIG. 17 is not lost with respect to movement of arm 20A.

In a further embodiment this lost motion connection can be in the form of a projection on one of the pawl lifter and first pawl engaging in a slot in the other of the pawl lifter and the first pawl.

It can be seen that this first full actuation of the outside release lever 40 has moved components 40, 52, 50, 46, 28 and 38. However, as shown in FIG. 3, the latch, i.e., claw 16 and first pawl 20, remain unmoved, and are in the same position as shown in FIGS. 1 and 2.

FIG. 4 shows the outside release lever having been fully released and returned to the position as shown in FIG. 1. This in turn, has also moved components 52, 50 and 46 to the position shown in FIG. 1. However, pawl lifter 28 remains in the position as shown in FIG. 3 by virtue of second pawl 38. In particular, note that as shown in FIG. 4, second ratchet tooth 34 is now in substantially the same position as first ratchet tooth 32 as shown in FIG. 1.

Thus, a subsequent full actuation of the outside release lever 40 causes ratchet abutment 48 to engage behind second ratchet tooth 34 and further rotate the pawl lifter 28 to the position as shown in FIG. 5. Pawl lifter abutment 62 causes arm 20A to rotate clockwise about pivot B thus releasing pawl abutment 22 from claw abutment 24 and allowing the claw 16 to rotate clockwise to its open position.

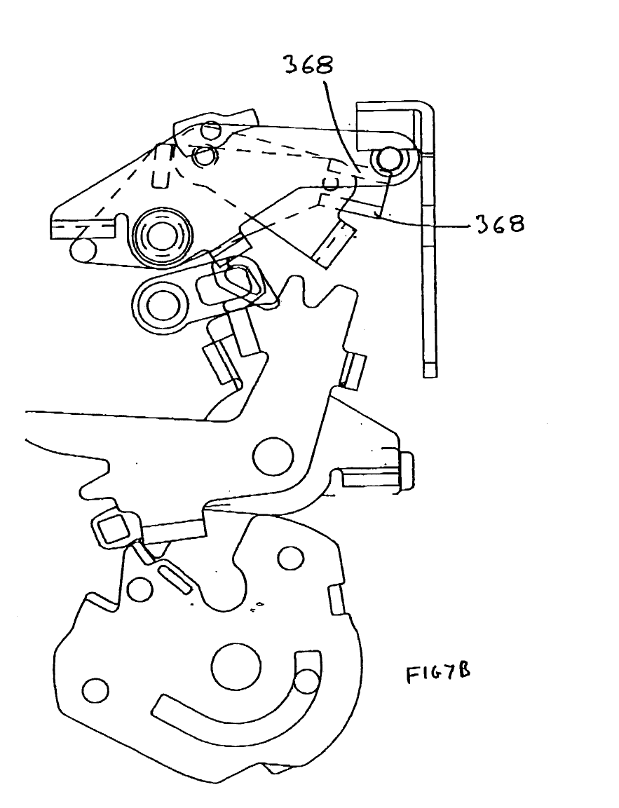

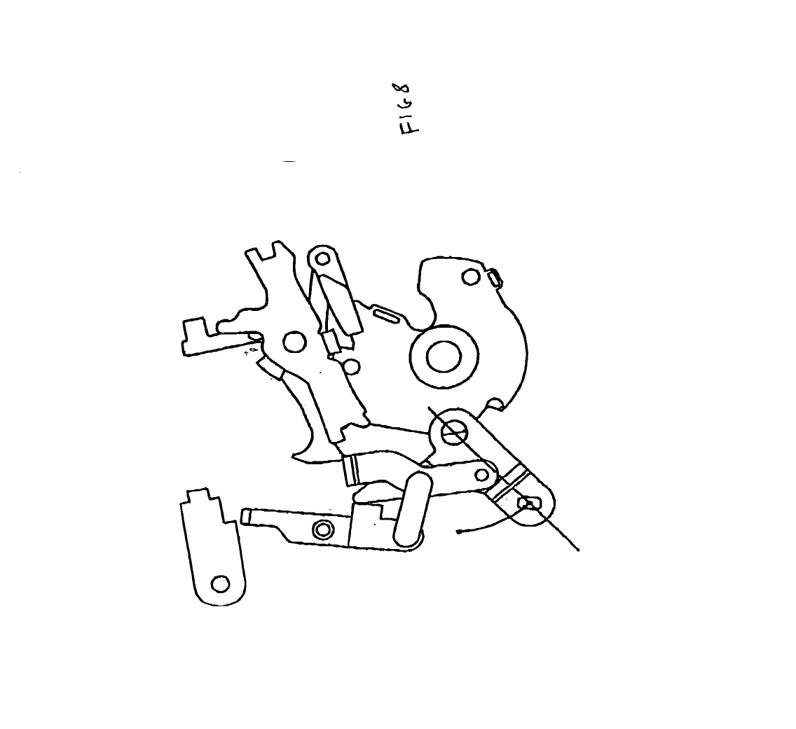

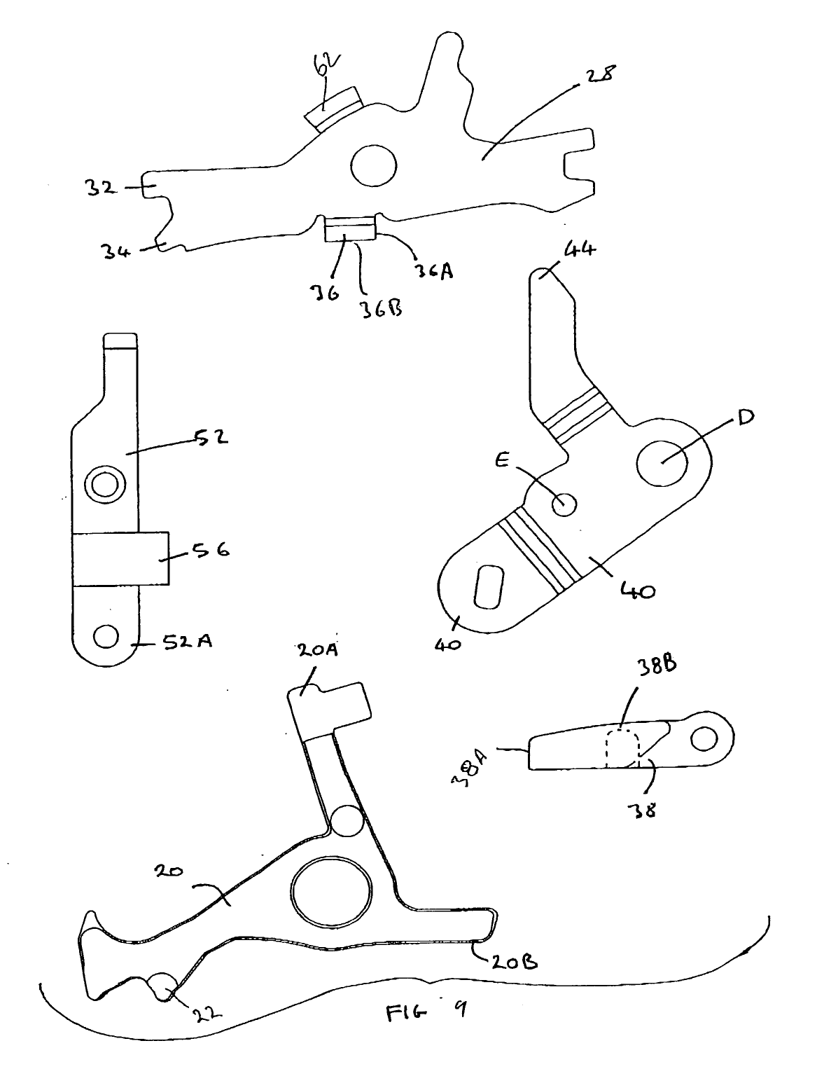

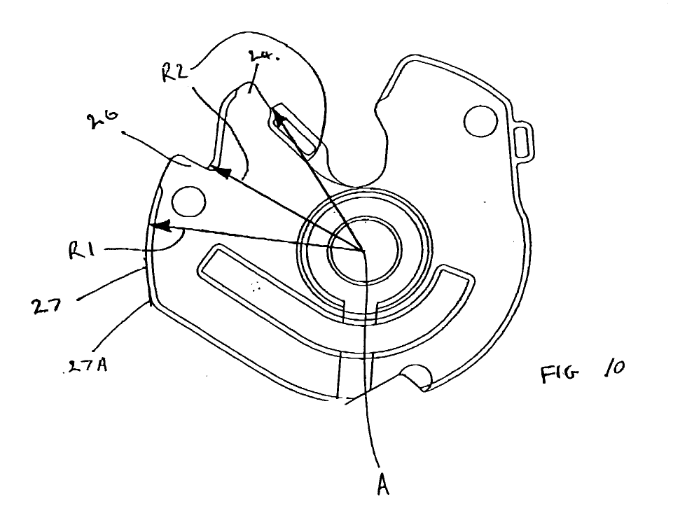

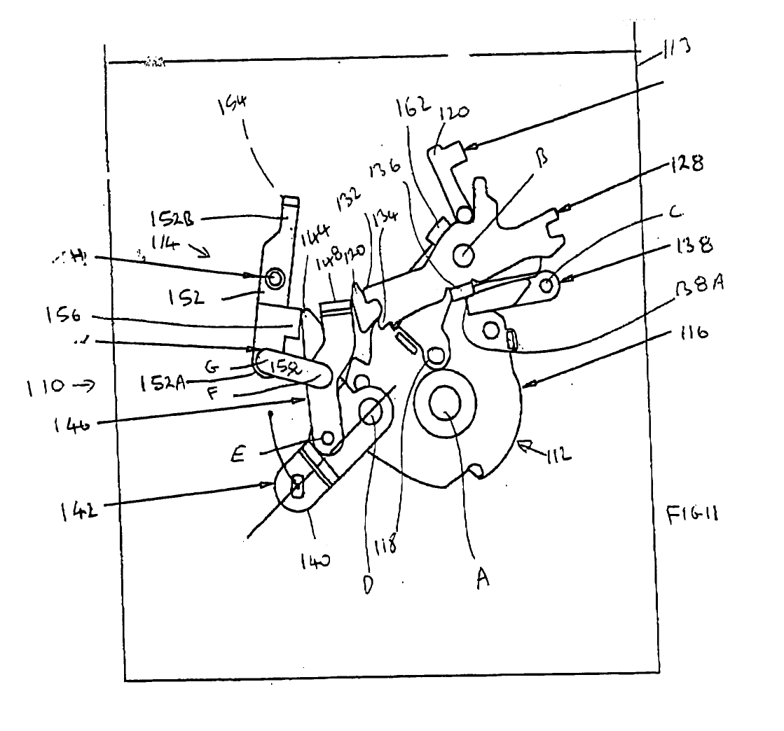

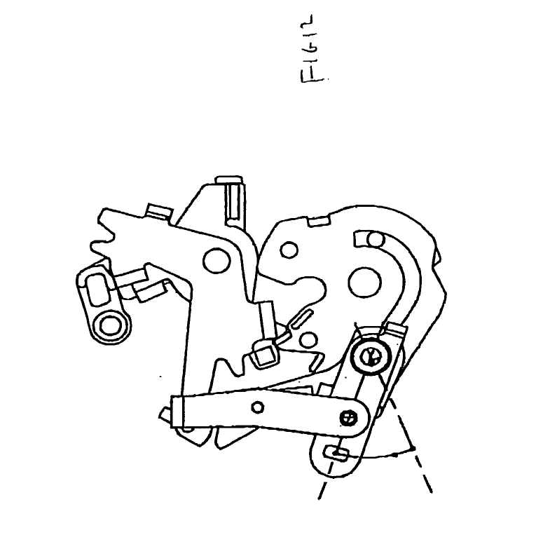

It should be noted from FIG. 5 that the second pawl 38 has been rotated counterclockwise when compared with FIG. 4. This is due to an abutment 20B on the first pawl 20 being moved (as the first pawl rotates) into engagement with an abutment 38B (see FIG. 9) of the second pawl 38, and hence rotating the second pawl counterclockwise against the second pawl bias spring. The pawl lifter abutment 36, can bypass end 38A of second pawl 38 to achieve the position shown in FIG. 8, because the second pawl 38 is being held in the position shown in FIG. 5 by the pawl 20 (i.e. by engagement of abutments 20B and 38B).

With the actuator 64 operating correctly, operation of the latch arrangement is as follows.

The latch starts from the position as shown in FIG. 1.

An initial operation of the outside door handle manually moves the latch components to the position as shown in FIG. 2. At this stage a sensing device, such as a switch, is triggered thereby indicating an opening request. The sensing device instructs the actuator to rotate the first pawl in a clockwise direction. However, the power actuator does not act instantaneously, and takes a finite amount of time to rotate the first pawl. Thus, in practice, continued lifting of the outside door handle might typically position the latch components somewhere between the position as shown in FIGS. 2 and 3 prior to the latch being power unlatched. Under these circumstances, clearly no subsequent manual operation of the outside door handle is required and the latch might typically move from the position shown in FIG. 3 to the position shown in FIG. 6. Release of the outside door handle and opening of the door will then move the latch components to the position shown in FIG. 8.

Operation of the latch arrangement when in the locked position shown in FIG. 7 is as follows.

As mentioned above, the toggle lock 58 has been rotated clockwise such that lock abutment 54 engages with toggle abutment 60. This prevents lock link 52 from rotating counter-clockwise. Thus, second link pivot G remains fixed relative to the chassis. First link pivot F is constrained to move about an arc centered at second link pivot G. When the outside release lever 40 is actuated the ratchet abutment 48 moves substantially upwardly relative to FIG. 7, and bypasses the first ratchet tooth 32, without engaging it. Hence, the actuation of the outside release lever does not move the pawl lifter, and the latch remains latched.

It should be noted that, in a further embodiment, the actuator 64 need not be present. Thus, the latch can only be opened manually and two complete actuations of the outside door handle will be required to open the latch.

The present invention (with or without actuator 64) has safety benefits in the event of a side impact on the vehicle. Thus, a side impact on the vehicle door may well deform the door such that the latch components move from the position shown in FIG. 1 through the position shown in FIG. 2 to the position shown in FIG. 3. However, under such circumstances the door does not open. This can be contrasted with known door latches wherein a single pull of the outside door handle opens the door. Such known latches therefore run the risk that a single side impact to the door will also move the latch components to their unlatched position and hence allow the door to open. The likelihood of an outside door handle being actuated twice as a result of a crash is significantly less than the likelihood of it being actuated once. Therefore the likelihood of the inventive latch opening during a crash is significantly less than the likelihood of known latches opening.

When the latch is in a first safety condition i.e. when the pawl abutment 22 is in engagement with first safety abutment 26 rather than abutment 24, the latch can still be locked, power opened and manually opened (when actuator 64 fails) in a manner similar to its operation when fully closed, (i.e., when pawl abutment 22 is in engagement with abutment 24).

FIG. 111 shows a further latch arrangement 110, similar to the latch arrangement 10, with components that fulfill substantially the same function labeled 100 greater.

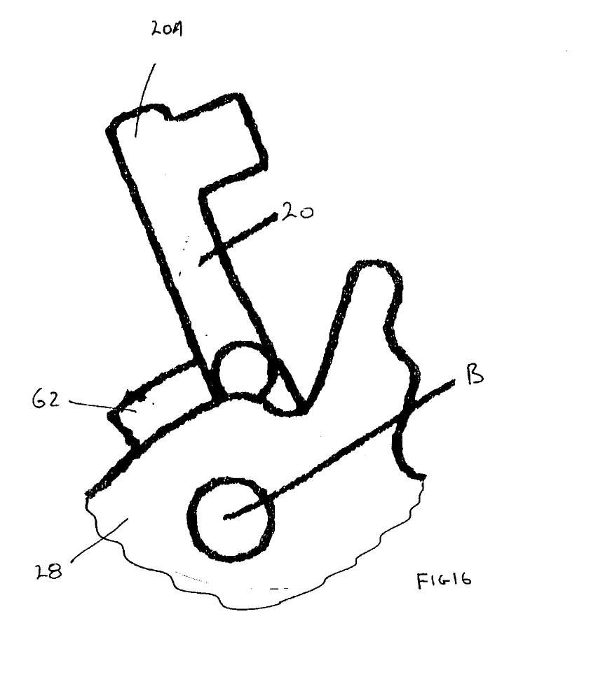

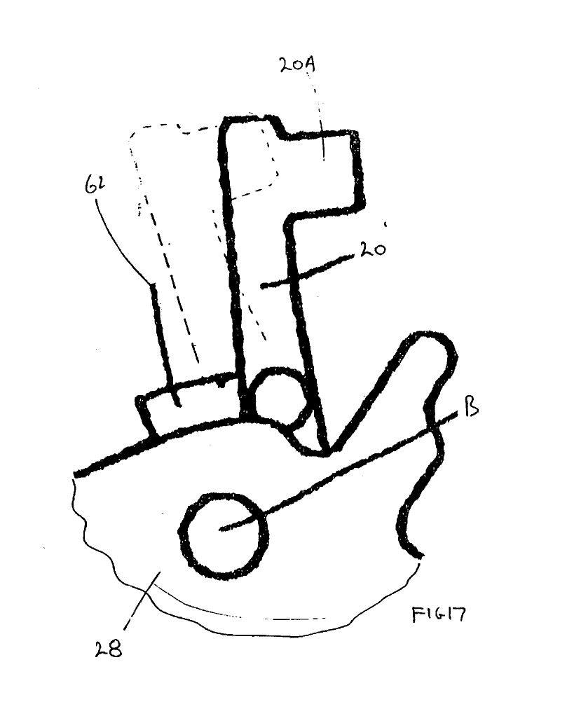

FIG. 11 shows the latch 110 in a latched condition, similar to the condition of latch 10 shown in FIG. 1. The only difference between latch arrangement 110 and latch arrangement 10 is that latch arrangement 110 does not include a lock toggle 58. Thus, latch arrangement 110 can be power unlatched or manually unlatched (when its power actuator fails) in a similar manner to latch 10. However, latch 110 cannot be locked. It should be noted that release mechanism 114 is in openable first condition as shown in FIG. 11 by virtue of the fact that latch 110 cannot be locked.

In a further embodiment, the actuator associated with latch arrangement 110 can be deleted to provide a non-power operable latch arrangement which cannot be locked.

In a further embodiment of a non-lockable latch, the lock link 152 and the link 150 of latch 110 can be deleted and replaced by a bias means, such as a spring, which lightly biases the ratchet lever 46 in a clockwise direction. The bias force ensures engagement of ratchet abutment 148 with appropriate ratchet teeth 132 and 134.

It should also be noted that in this embodiment the ratchet teeth and ratchet abutment are in substantially permanent operable engagement. Hence, the latch cannot be locked by virtue of disengagement of the ratchet teeth and ratchet abutment. In yet further embodiments, the latch could alternatively be locked by virtue of a block mechanism or a free wheel type mechanism positioned somewhere in the transmission path between the outside door handle and the first pawl.

FIGS. 1A to 7A and 1B to 7B together show a latch arrangement 210 which can be selectively opened by operation of an outside release handle 241 or by operation of an inside release handle 341. To ensure clarity, FIGS. 1A to 7A show only those components associated with the outside handle 241 and FIGS. 1B to 7B show only those components associated with the inside handle 341. It will be noted that claw 216, first pawl 220, and pawl lifter 228 are shown in all of FIGS. 1A to 7A and 1B to 7B since these components are operated by both the inside and outside handles.

FIGS. 1A through 7A show further embodiments of a latch arrangement 210 wherein features which perform substantially the same function as in latch arrangement 10 have been labeled 200 greater. Note also that pivots 2E, 2D and 2H as shown in FIG. 2A are the functional equivalents of pivots E, D and H of latch arrangement 10.

FIG. 13 shows that lock link 252 is pivotally mounted at pivot 2H which is coincident with pivot 2D about which outside release lever 240 pivots. Furthermore, a pin 267 on ratchet lever 246 projects between a slot formed by guides 268 of lock link 252. This pin and slot arrangement replaces link 50 of latch arrangement 10.

Actuation of outside release lever 240 (in the event of failure of actuator 264) causes it to rotate clockwise about pivot 2D. This causes clockwise rotation of projection 244 that in turn allows return abutment 256 of lock link 252 to also rotate clockwise about pivot 2D/2H. Thus, it can be seen that an initial movement of outside release lever 240 causes release lever 240, outside lock link 252 and ratchet lever 246 to all rotate in unison clockwise about pivot 2D/2H to the position shown in FIG. 2A whereupon lock link 252 contacts an abutment (not shown). Continued clockwise rotation of outside release lever 240 causes relative rotation between outside release lever 240 and now stationary lock link 252. Thus, ratchet lever 246 moves generally upwardly relative to lock link 252, being guided by the pin 267 and slot 268 so as to engage and move first ratchet tooth 232, to the position shown in FIG. 3A.

Release of outside release handle 241 moves the components to the position shown in FIG. 4A, and subsequent full actuation of outside release handle 241 moves the components to the position as shown in FIG. 5A, thereby releasing the latch.

The latch arrangement 210 can be locked by movement of lock toggle 258 to the position shown in FIG. 7A. Under these circumstances lock abutment 254 of lock link 252 engages with toggle abutment 260, thereby preventing lock link 252 rotating clockwise as outside release lever 240 is actuated. Under these circumstances guides 268 guide ratchet abutment 248 to the left of first ratchet tooth 232 when viewing FIG. 7, by virtue of pin 267 of ratchet lever 246 to the position shown in FIG. 12.

FIGS. 1A through 7A show how manually actuating outside door handle 241 twice (in the event of failure of actuator 264) causes unlatching of the latch.

The invention is equally applicable to inside door handles. Thus, FIGS. 1B to 7B are views corresponding to FIGS. 1A to 7A showing operation of an inside door handle 341 (shown schematically on FIG. 1B), in the event of failure of the power actuator 264.

FIGS. 1B through 7B show the latch arrangement 210 with various components associated with the inside door handle. Those components associated with the outside door handle are not shown for clarity. In the event of failure of actuator 264, the latch can be manually opened by manually actuating inside release handle 341 twice, in a manner similar to when the outside release handle 241 is used to manually open the door.

A comparison can be made with those features associated with the outside release handle 241, and equivalent features associated with inside release handle 341.

Thus first and second inside ratchet teeth 332 and 334, equate to the similar components 232 and 234 associated with the outside release handle. Inside release lever 340 equates with outside release lever 240. End 342 of inside release lever 340 is actuated by lever 370 that pivots about axis 370A. The lower end 370B of lever 370 is pulled out of the plane of the paper, towards the reader, by a bowden cable 371 actuated by inside release handle 341. This causes abutment 370C to act on pin 342A to rotate inside release lever 340 clockwise about pivot 3D/3H. Projection 344 engages with return abutment 356 in a manner similar to the engagement between projection 244 and return abutment 256.

Inside ratchet lever 346 includes inside ratchet abutment 348, just as outside ratchet lever 246 includes outside ratchet abutment 248. Inside lock link 352 equates to outside lock link 252. Inside lock abutment 354 cooperates with inside lock toggle 358 and inside toggle abutment 360 in a manner similar to the cooperation between outside lock abutment 254, outside lock toggle 258, and outside toggle abutment 260. Inside pin 367 cooperates with inside guides 368 in a manner similar to the cooperation between outside pin 267 and outside guides 268.

Common pivots 3D/3H equate to pivot 2D/2H. Inside ratchet lever 346 is pivoted at pivot 3E onto inside release lever 340 in a manner similar to the pivoting of outside ratchet lever 246 via pivot 2E onto outside release lever 240. Inside lock toggle 358 is pivoted to the chassis at pivot 3J, in a manner similar to the pivoting of outside lock toggle 258 to the chassis via pivot 2J.

FIG. 14 shows the lock toggle 358 rotated in an counter-clockwise direction, so that operation of the inside release handle 341 does not open the latch.

Latch arrangement 210 can have various security states. With the latch components as shown in FIGS. 1A and 1B, the latch is unlocked, since operation of either the inside release handle 341 or the outside release handle 241 will unlatch the latch.

With the latch components positioned as shown in FIG. 7A and FIG. 1B, the latch is locked. Operation of the outside release handle will not open the door but operation of the inside release handle will open the door.

With the latch components positioned as shown in FIG. 7A and FIG. 7B, the latch is superlocked, since operation of either the outside release handle or the inside release handle will not open the door. The term superlocked is also known as deadlocked.

With the latch components positioned as shown in FIG. 1A and FIG. 7B, the latch is in an unlocked child safety on condition, since operation of the inside release handle will not open the latch, but operation of the outside release handle will open the latch.

Latch arrangement 210 has an outside release mechanism 214, and an inside release mechanism 314. Outside release mechanism 214 includes outside release lever 240, outside ratchet lever 246, outside lock link 252, and first and second ratchet teeth 232 and 234 of pawl lifter 228. Inside release mechanism 314 includes inside release lever 340, inside ratchet lever 346, inside lock link 352, and first and second inside ratchet teeth 332 and 334 of pawl lifter 228.

It will be appreciated that when using either the inside or the outside release handle to open the latch, the pawl lifter 228 is operated. However, it will also be appreciated that when using the outside release handle 241, the pawl lifter 228 is moved by virtue of the first and second outside ratchet teeth 232 and 234, and in particular is not moved by virtue of the first and second inside ratchet teeth 332 and 334. Conversely, when opening the latch by operation of the inside release handle, it is the first and second inside ratchet teeth 332 and 334 that are operated, and in particular the outside first and second ratchet teeth 232 and 234 are not operated.

Thus, as shown in FIG. 1A, the outside release mechanism 214 is in an openable condition, since operation of the outside release lever will cause outside ratchet abutment 248 to sequentially engage first outside ratchet tooth 232 and then engage second outside ratchet tooth 234.

As shown in FIG. 7A, the outside release mechanism 214 is in a non-openable condition since operation of the outside release handle will not open the latch. It will be appreciated that the openable/non-openable condition of the outside release mechanism 214 is solely dependent upon the position of the lock toggle 258, and in particular, is independent of the openable/non-openable condition of the inside release mechanism 314. Similarly, the openable/non-openable condition of the inside release mechanism 314 is determined solely by the position of the inside lock toggle 358, and in particular, is independent of the openable/non-openable condition of the outside release mechanism 214.

FIG. 1A shows the outside release mechanism 214 in an openable condition. FIG. 7A shows the outside release mechanism 214 in a non-openable condition.

FIG. 1B shows the inside release mechanism 314 in an openable condition. FIG. 7B shows the inside release mechanism 314 in a non-openable condition. The combination of the openable/non-openable conditions of the outside release mechanism 214 and inside release mechanism 314 provide for different statuses of the latch arrangement 210 as described above (unlocked, locked, superlocked and unlocked child safety on conditions).

FIG. 1 therefore shows the release mechanism 14 in an openable condition, since two operations of the inside door handle will open the latch. FIG. 1 also shows the latch in a fully latched condition, since pawl abutment 22 is in engagement with claw abutment 24 (as opposed to the claw first safety abutment 26). Thus, FIG. 1 shows the release mechanism in an openable first condition.

As shown in FIG. 4 the release mechanism is also openable, since it is not locked. Furthermore, it is still fully latched, since the position of the claw has not changed from the position shown in FIG. 1. However, in the position of the pawl lifter has changed from the position shown in FIG. 1, and therefore FIG. 4 shows the release mechanism in an openable second condition. It will be appreciated that, as shown in FIGS. 1A, 1B, 4A, 4B, 7A and 7B, the latch is fully latched.

With the actuator 264 operating correctly, an initial operation of the outside door handle or the inside door handle triggers a respective sensing device, such as a switch, thereby indicating an opening request, which instructs the actuator to rotate the first pawl in a clockwise direction.

In further embodiments, the actuator 264 could be deleted thereby providing a latch that can only be manually opened.

Although preferred embodiments have been disclosed, a worker of ordinary skill in this art would know that modifications would come within the scope of this invention.

Thus, the following claims should be studied to determine the true scope and content of this invention.

1. A latch arrangement comprising:
a latch and a release mechanism operable such that with said release mechanism in an openable first condition and with the latch fully latched, an initial actuation of the release mechanism changes the state of the release mechanism to an openable second condition, distinct from the openable first condition, and with the latch remaining fully latched; and
wherein a subsequent actuation of the release mechanism unlatches the latch.

2. A latch arrangement as defined in claim 1 in which the release mechanism has a non-openable condition such that, when in the non-openable condition, any number of actuation of the release mechanism does not unlatch the latch.

3. A latch arrangement as defined in claim 1 in which the latch includes a latch bolt releasably retainable in a closed position by a first pawl.

4. A latch arrangement as defined in claim 3 in which the first pawl is operable by a pawl lifter, the pawl lifter being moveable relative to the first pawl from a first relative position, corresponding to the openable first condition of the release mechanism, to a second relative position corresponding to the openable second condition of the release mechanism.

5. A latch arrangement as defined in claim 4 in which the pawl lifter is moveable relative to the first pawl by virtue of a lost motion connection between the pawl lifter and first pawl.

6. A latch arrangement as defined in claim 4 in which the pawl lifter is retainable in the second relative position by a second pawl.

7. A latch arrangement as defined in claim 6 wherein the second pawl is not capable of retaining the pawl lifter in its second relative position with the first pawl in a released position.

8. A latch arrangement as defined in claim 3 in which the latch bolt engages the first pawl to keep the first pawl substantially in its released position when the latch bolt is in an open position

9. A latch arrangement as defined in claim 6 in which the first pawl includes an abutment engageable with the second pawl such that when the abutment engages the second pawl to move the second pawl to a position where it is incapable of retaining the pawl lifter in its second relative position, the first pawl is in its released position.

10. A latch arrangement as defined in claim 1 in which the release mechanism includes a ratchet mechanism having a first and second ratchet tooth to provide for the changing of the state of the release mechanism between the openable first condition and the openable second condition and between the openable second condition of the release mechanism and the unlatched condition of the latch upon respective engagement with a ratchet abutment.

11. A latch arrangement as defined in claim 10 in which the ratchet teeth and ratchet abutment are in substantially permanent operable engagement.

12. A latch arrangement as defined in claim 10 in which the ratchet teeth and ratchet abutment are capable of being maintained in a disengaged position to provide for a non-openable condition of the release mechanism.

13. A latch arrangement as defined in claim 10 in which one of the first and second ratchet teeth and ratchet abutment are mounted on a ratchet lever.

14. A latch arrangement as defined in claim 13 in which the ratchet abutment is mounted on a ratchet lever and the ratchet teeth are mounted on the pawl lifter.

15. A latch arrangement as defined in claim 13 in which the ratchet lever is pivotally mounted on a release lever.

16. A latch arrangement as defined in claim 1, said latch arrangement being further operable by a power actuator.

17. A latch arrangement as defined in claim 16 in which the power actuator is connected on a first pawl transmission path side of the ratchet mechanism.

18. A latch arrangement as defined in claim 16 in which the power actuator is connected on a first pawl transmission path side of the connection between the pawl lifter and the first pawl.

19. A latch arrangement as defined in claim 1 in which the release mechanism is connected to an outside door handle.

20. A latch arrangement as defined in claim 1 including a further release mechanism operable such that when said further release mechanism in an openable first condition with said latch fully latched, an initial actuation of the further release mechanism changes the state of the further release mechanism to an openable second condition, different from the first condition of the further release mechanism while the latch remains fully latched, and wherein a subsequent actuation of the further release mechanism unlatches the latch.

21. A latch arrangement as defined in claim 20 in which the further release mechanism has a non-openable condition such that, when the further release mechanism is in the non-openable condition, any number of operations of the further release mechanism does not unlatch the latch.

22. A latch arrangement as defined in claim 21 in which the pawl lifter is moveable relative to the pawl from said first relative position, corresponding to the openable first condition of the further release mechanism, to said second relative position corresponding to the openable second condition of the further release mechanism.

23. A latch arrangement as defined in claim 20 in which the further release mechanism is connected to an inside door handle.
